(19) United States
(12) Patent Application Publication
(10) Pub. No.: US 2011/0132274 A1
(43) Pub. Date: Jun. 9, 2011

(54) ANIMAL ENCLOSURE

(76) Inventor: Matthew F. Cagle, Morehead City, NC (US)

(21) Appl. No.: 12/957,906

(22) Filed: Dec. 1, 2010

Related U.S. Application Data
(60) Provisional application No. 61/266,271, filed on Dec. 3, 2009.

(51) Int. Cl. A01K 1/03

(52) U.S. Cl. 119/498; 119/501

(57) ABSTRACT

An animal enclosure including a frame having a first frame end, a second frame end, and a biasing member between the frame ends, wherein the biasing member biases the first frame end away from the second frame end; a shell overlying the frame to define an enclosed space within the frame, the shell being flexible such that the frame and the shell are movable between a collapsed condition and an opened condition; wherein the first frame end defines an opening through which the animal enters the enclosed space.

The present invention claims the benefit of the provisional application no. 61/266,271, filed Dec. 3, 2009.

### TECHNICAL FIELD

This present invention generally relates to animal enclosures. More particularly, the present invention relates to an animal enclosure having a collapsible frame. Most particularly, the present invention relates to an animal enclosure having a coil spring frame.

### BACKGROUND OF THE INVENTION

Animal enclosures are used to provide a den for animals or “crate” an animal when leaving them unattended or at a boarder. In most instances, these enclosures, which are often referred to as crates, are constructed from rigid plastic in the form of an elongate box with openings in the sides and a swinging gate-like door. Other crates are constructed of wire panels that interconnect with each other to form a crate. One advantage of the wire panel construction is that the panels may be separated and collapsed to transport the crate. Lastly, soft-sided crates have been created by using flexible rods that are inserted through loops on the exterior of the tent and bowed to support the tent in an open condition. To collapse the tent, the rods are removed.

Often during hunting, it is desirable to hunt from a blind to avoid spooking the game. For example, in duck hunting, it is desirable to conceal the presence of a hunting dog or other animal from ducks, geese, or other fowl. Typically, this type of hunting is done in an agricultural field making uncovered animals highly visible from the air. Therefore, it is desirable to crate a hunting dog or other animal so that they are less visible to game or fowl. To that end, the present invention provides an animal enclosure that can be used to confine an animal and when used in hunting applications conceal the animal. Collapsible animal enclosures in the prior art are too bulky for use in hunting applications. Therefore, a need exists for animal enclosure that is easily transported and can be collapsed when not in use.

### SUMMARY OF THE INVENTION

The present invention generally provides an animal enclosure including a soft-sided shell, and an internal frame having first and second end frame members biased toward an open condition by an extendable support located between said end frame members. According to one embodiment of the invention, the extendable support is a coil spring member. In accordance with another embodiment, the coil spring member and end frame members are formed from a single wire.

### BRIEF DESCRIPTION OF THE FIGURES

FIG. 1 is a perspective view of a animal enclosure according to the concepts of the present invention in an open condition;

FIG. 2 is a perspective view animal enclosure according to the concepts of the present invention in a collapsed condition;

FIG. 3 is a perspective view of an animal enclosure according to the concepts of the present invention partially cut away to show details of its construction;

FIG. 4 is a front perspective view of an animal enclosure according to the concepts of the present invention shown with the door flaps in an open position;

FIG. 5 is a front perspective view with the door flaps shown in a closed condition;

FIG. 6 is a side perspective view of a frame of an animal enclosure according to the concepts of the present invention;

### DETAILED DESCRIPTION OF THE INVENTION

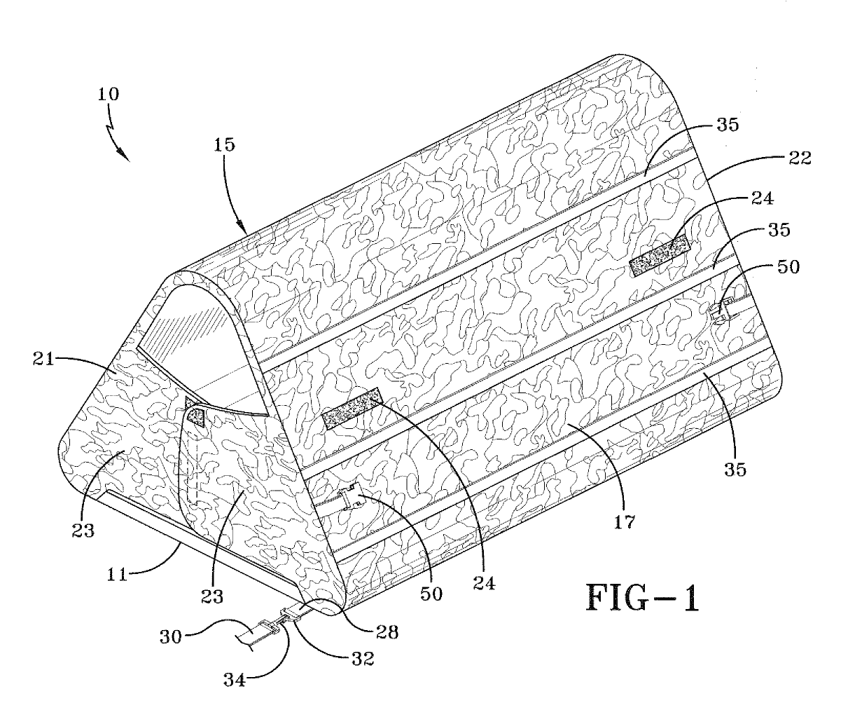

One example of an animal enclosure according to the concepts of the present invention is depicted in FIG. 1. The animal enclosure 10 may have any shape. A flat base 11 is desirable to allow the animal enclosure 10 to be set up on a surface without it rolling or tipping. A non-flat base could be used and enclosure 10 staked or otherwise secured to the ground to avoid rolling. In the example shown, Animal enclosure 10 has a generally triangular shape.

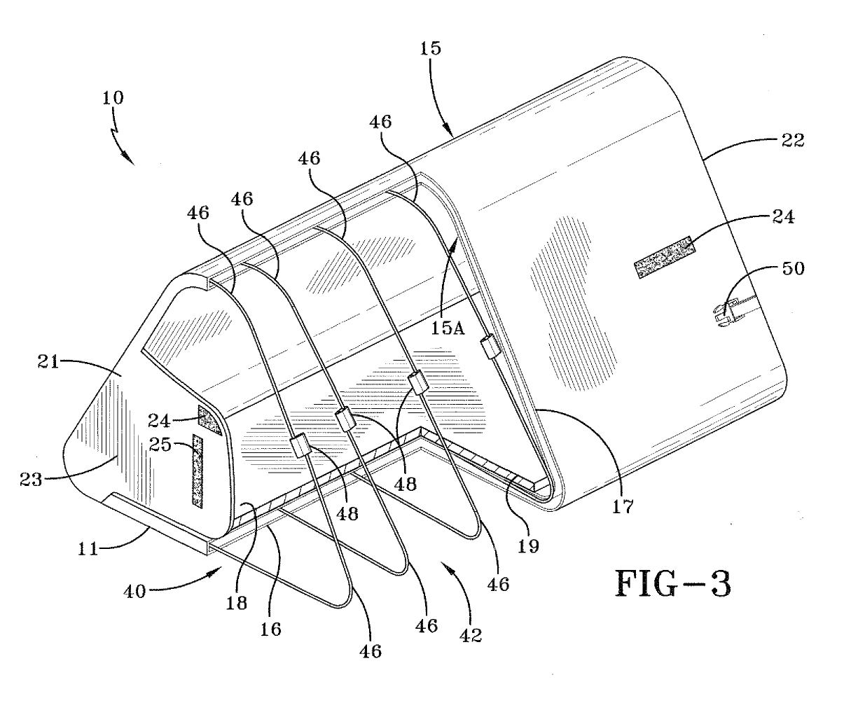

As best shown in FIG. 3, the animal enclosure 10 has an outer shell or cover 15 supported by a frame 20. The shell 15 is generally constructed of a flexible material to allow its collapse when not in use. To that end, any fabric would be suitable, including natural fibers, synthetic materials, or combinations thereof. In the example shown, the shell 15 is constructed of a synthetic mesh material to improve breathability. Shell 15 may have a tubular shape that encompasses the frame 20. Shell 15 may be constructed of a single type of material or multiple materials may be used. For example, the base panel 16 may be constructed of non-mesh material while the sides 17 are constructed of a mesh material to improve air flow. Since the base panel 16 may be located on damp surfaces, it may be constructed of a water resistant or waterproof material. The sides 17 may also be constructed of these materials. When using mesh sides, flaps or other coverings made of these materials that may be used to cover or shield the mesh sides when inclement weather strikes. Alternatively, breathable water-resistant or waterproof fabrics such at GoreTex® may be used to construct shell 15. As shown in FIG. 3, enclosure 10 may further include a liner 15A that attached to the inside of shell 15 such that the frame 20 is housed between shell 15 and liner 15A. In general, liner 15A may have the same construction as shell 15A.

To pad the base 11 of frame 20, a pad 18 may be inserted within enclosure 10 over base 11 of frame 20. Pad 18 may be constructed of any suitable padding including natural materials, synthetic materials, or combinations thereof. The pad 18 may include a casing 19 that encompasses the padding material or provides a removable cover for pad 18. It will be appreciated that a removable casing 19 may facilitate cleaning after the enclosure 10 is used. To provide further waterproofing or when using a non-waterproof base panel 16, pad 18 or casing 19 may be constructed of a water-resistant or waterproof material as described with respect to base panel 16 above. A camouflage coloring scheme may be applied to the outer surface 17 of the animal enclosure 10 to facilitate concealment of the animal during hunting. Alternatively, the enclosure 10 may have no pattern on the outer surface. Any color scheme may be used. Shell 15 may be open at either end (FIG. 8) to allow ingress and egress of the animal. In the depicted embodiment, one or more flaps 23 may be provided to selectively close the ends 21,22 of the animal enclosure 10 and confine the animal within the animal enclosure 10. Alternatively, the shell 15 may be constructed to have one or more closed ends. In these instances, a door or other opening may be provided within the end panels to allow ingress and egress of the animal.

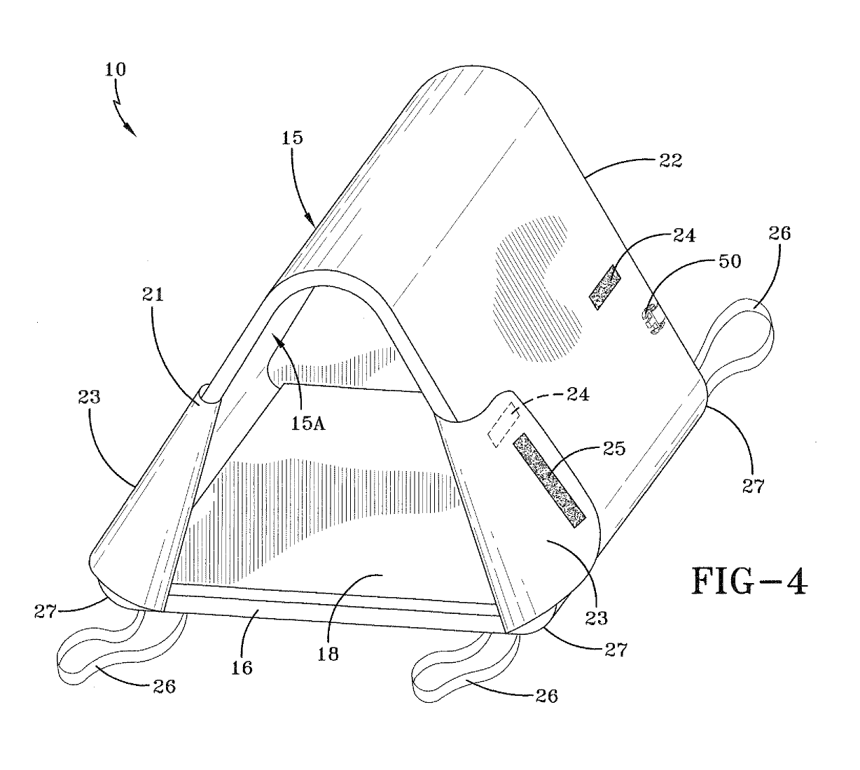

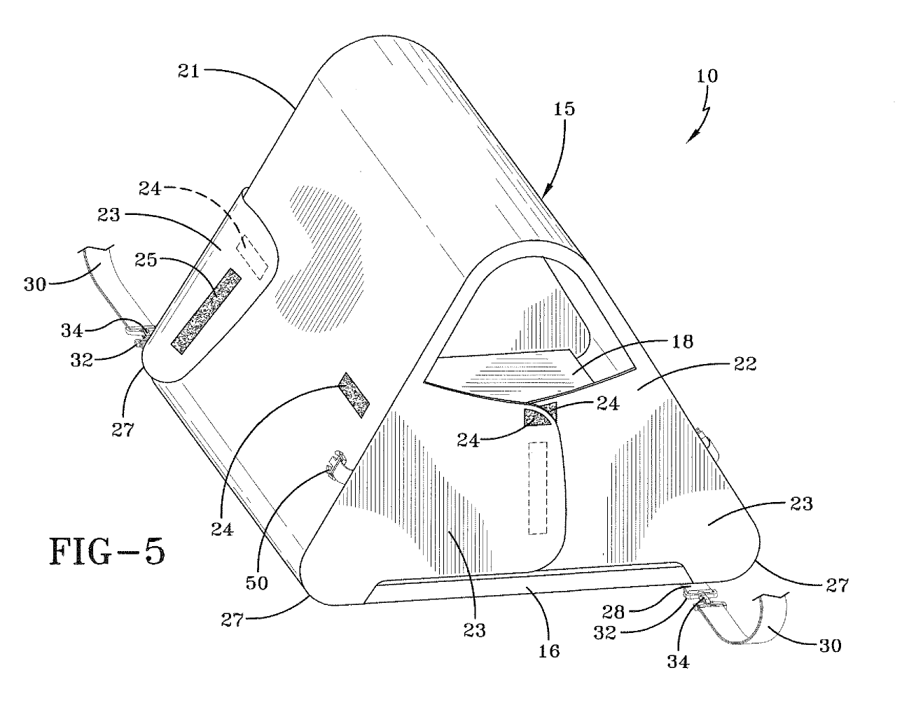

To help secure the flaps 23 in an open position, as depicted in FIGS. 4 and 5, fasteners 24 may be provided on the flaps 23 and the outer shell 15 as shown in FIG. 1. For example, Velcro® tabs may be applied to the flaps 23 and shell 15 to bold flaps 23 in the open position. Likewise, to secure flaps 23 in a closed position, fasteners 25 may be provided on the flaps 23 to secure them to each other or to a surface of shell 15. In the example shown in FIG. 1, hook and loop fasteners such as Velcro® may be provided on facing surfaces of the flaps 23 that overlap each other and are secured to each other when the flaps 23 are in the closed position. Other fasteners, including but not limited to snaps, pins, hooks, toggles, zippers, or ties may also be used.

In some instances, it may be desirable to secure the blind to the ground or other surface. To that end, as shown in FIG. 4, animal enclosure 10 may be provided with securement members 26 that facilitate staking or otherwise securing the animal enclosure 10. For example, straps or loops may be provided at the corners 27 (FIGS. 4 and 5)of the animal enclosure 10 that may be used to tie the enclosure 10 to a tree, stake, or other structure. It will be appreciated that the securement members may attach to the frame 20 or the shell 15 as shown.

As shown in FIG. 1, a transport member including a strap, a clip, or handle may be provided to facilitate carrying the animal enclosure 10. In the example shown, a pair of tabs 28 are attached to base 11 of the blind at opposite corners thereof for attachment of a strap 30 thereto. In the example shown, the tabs are provided with loops 32 to which the strap 30 may be releasably attached, as by a snap hook 34 or other suitable fastener. Alternatively or in addition to a strap or handle, enclosure 10 may be provided with a clip, hook or other hanger that allows the enclosure 10 to be clipped or hung from a belt for transport or hung elsewhere for storage.

Since enclosure 10 may be used in fields or other locations that are wet, the base panel 16 of shell 15, liner 15A and/or pad 18 may be waterproofed or otherwise constructed of a water repellant/resistant material to keep the animal dry. Similarly, the upper surfaces of the blind may be constructed of waterproof or repellant materials.

When using animal enclosure 10 in a hunting application, it may be desirable to attach natural vegetation to the exterior of animal enclosure 10 to further help it blend with its surroundings. To that end, animal enclosure 10 may include vegetation fasteners 35, such as straps, elastic bands, eyes, loops, or hook and loop fasteners to facilitate attachment of this vegetation.

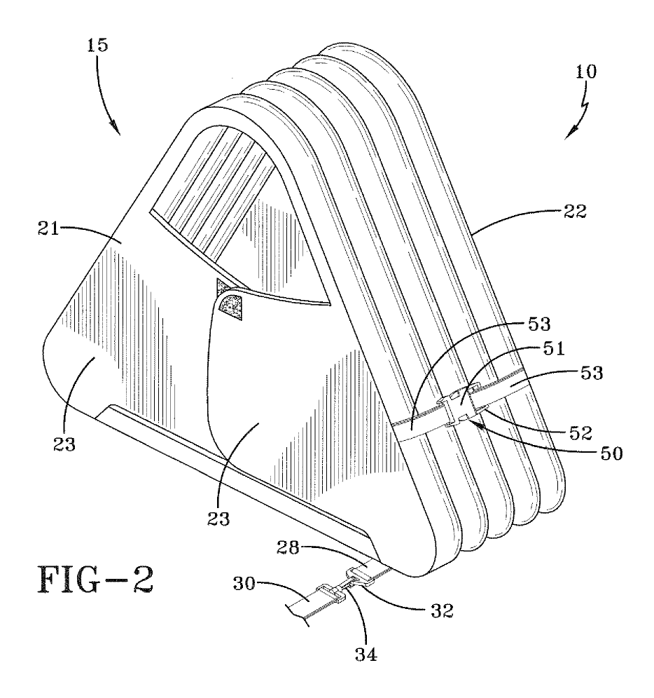

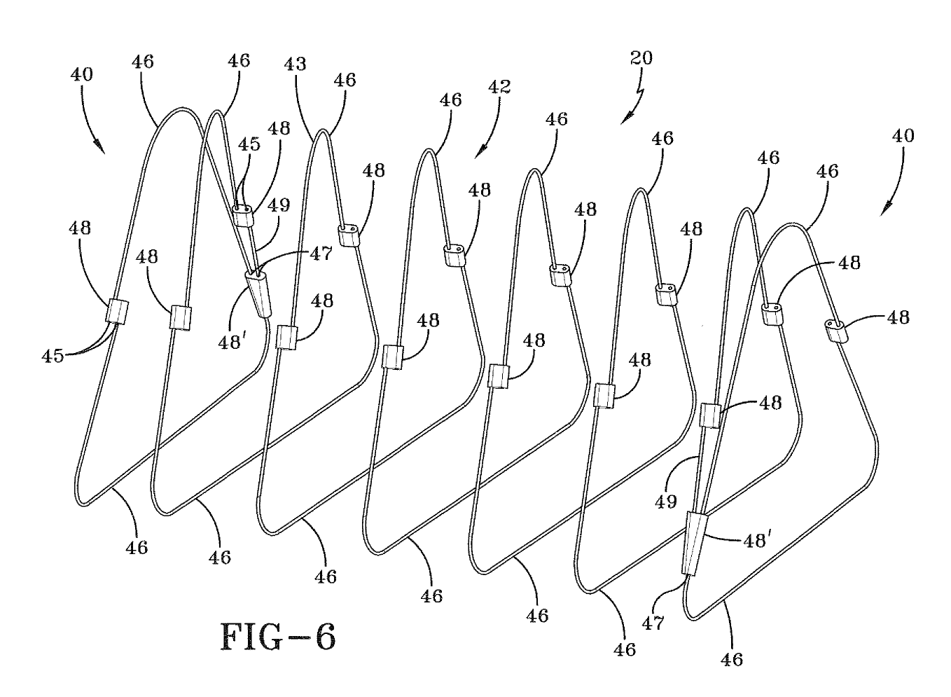

Referring to FIGS. 1 and 2, the frame 20 of the animal enclosure 10 is made collapsible to facilitate transport of the animal enclosure 10. In the embodiment shown, frame 20 is designed to act as a spring-like member that rests in an expanded or open condition defining the shape of the blind for use. As depicted in FIG. 6, enclosure 10 may have a triangular shape defined by a pair of frame ends 40 spaced by a biasing member 42 extending between the first and second frame ends 40. Biasing member 42 may include any member that biases first and second ends 40 away from each other and may include traditional springs, air cylinders, or inflatable bellows or bladders that may be filled to hold the frame ends 40 in an open condition and opened to allow collapse of the frame ends 40. In the example shown, biasing member 42 is a coil spring 43. It will be appreciated that the frame ends 40 and coil spring 43 may be constructed in a unitary fashion as a continuous member or constructed of plural members attached to each other. In the example shown in FIG. 2, the frame is constructed of plural segments 46 joined by couplers 48. As best seen in FIG. 6, couplers 48 may include somewhat rectangular members having parallel bores 45 extending there through that each receive an end of a segment 46. For example, a downwardly extending end may enter a bore 45 on one side of coupler 48 from the top of coupler 48 while an adjacent segment 46 may have an upwardly extending end entering the coupler 48 from a bottom end of the opposite bore of coupler 48. The ends of segments 46 are able to rotate within coupler 48 effectively forming a pivoting relationship between the ends of segments 46 that allows the coupler 48 to pivot upon collapsing or expanding of frame 20. For instance, as shown in FIG. 6, couplers 48 are pivoted outward to maximize the spacing between ends of segments 46 when frame 20 is in an open condition. When collapsed, it will be appreciated that couplers 48 rotate inward allowing adjacent segments 46 to reside in the same plane when frame 20 is fully collapsed. To attach the frame ends 40, coupler 48 may be modified to accommodate three segments such that a lower segment of frame end enters a bottom side of coupler 48 while an upper segment 46 of frame end 40 extends from a top of said coupler 48 and a third bore is provided for attachment of a segment 46 of biasing member 42. In the example shown in FIG. 6, a triangular shaped coupler 48′ is provided with two openings 47 on a top side and a single opening 47 on the lower side thereof to permit this attachment between the biasing member 42, a transition segment 49, and frame ends 40.

The frame 20 may be constructed of any suitable material for supporting the shell 15. As shown, frame 20 may be constructed of a spring-like material or shape memory material including, for example, metal, polymer, fiberglass, or composites thereof among others that may be compressed from an expanded condition to a collapsed condition. The biasing member 42 may be part of frame 20 and constructed of a like material. With reference to FIG. 6, the example frame 20 is shown in the expanded condition such as when enclosure 10 is in use. Since the frame 20 may be biased toward the open position, to facilitate transport, it is desirable to provide a fastener 50 that holds the frame 20 in a collapsed condition (FIG. 2). Any fastener 50 may be used including ties, zippers, snaps, hook and loop fasteners, or clips. As best shown in FIG. 2, the fastener 50 may be provided on the shell 15 so that the frame 20 and shell 15 may be collapsed simultaneously. In this embodiment, the user would not have to remove the shell 15 before collapsing the frame 20. In the example shown, a two piece clip 50 is provided to hold enclosure 10 in a collapsed condition. Clip 50 has a first piece 51 attached to shell 15 near the first end 21 of the animal enclosure 10 and a second piece 52 attached to shell 15 near the second end 22 of the animal enclosure 10 such that the two pieces 51, 52 are brought together and secured to each other to hold the animal enclosure 10 in the collapsed condition. A strap 53 may be used to attach each piece 51, 52 of clip 50 to shell 15. As will be appreciated, more than one clip 50 or other fastener may be used. For example, in the example shown, a pair of clips 50 are provided, each located on opposite sides of the frame 20 to hold it in the collapsed condition (FIG. 2). Alternatively, a storage bag, sleeve, or other separate member may be provided so that the user collapses frame 20 and stuffs it into the storage bag to hold it in the collapsed condition.

The foregoing describes one embodiment of an animal enclosure according to the concepts of the present invention. The animal enclosure may be used as a blind to conceal an animal while hunting, and may also be used as a pet crate to confine an animal. Advantageously, the animal enclosure of the present invention may be collapsed for storage where other pet crates are large, bulky and are not easily collapsed. It will be appreciated that various modifications may be made to the animal enclosure shown and described herein without departing from the present invention. Therefore for an appreciation of the scope of the invention, reference should be made to the following claims.

What is claimed:

1. An animal enclosure comprising:
a frame having a first frame end, a second frame end, and a biasing member between said frame ends, wherein said biasing member biases said first frame end away from said second frame end;
a shell encompassing said frame to define an enclosed space within said frame, said shell being flexible such that said frame and said shell are movable between a collapsed condition and an open condition;
wherein said first frame end defines an opening through which the animal enters said enclosed space.

2. The animal enclosure of claim 1, wherein said second frame end defines a second opening for receiving the animal within the enclosed space.

3. The animal enclosure of claim 1, wherein said shell includes end flaps adapted to cover at least a portion of said first and second frame ends; wherein at least one of said flaps is releasably attached to allow the animal to enter the opening defined in said first frame end.

4. The animal enclosure of claim 1, wherein said shell has a camouflage pattern on an outer surface thereof.

5. The animal enclosure of claim 1, wherein said biasing member is a coil spring.

6. The animal enclosure of claim 5, wherein said first and second frame ends are formed integrally with said biasing member.

7. The animal enclosure of claim 1 further comprising a clip attached to one of the said frame and said shell said clip having a first piece near the first frame end and a second piece near the second frame end attachable to said first piece to hold said shell and said frame in the collapsed condition.

8. The animal enclosure of claim 1, wherein said shell includes a base panel extending below a base of said frame.

9. The animal enclosure of claim 8, wherein said base panel is constructed of a water resistant material.

10. The animal enclosure of claim 1 further comprising a pad insertable within the enclosed space.

11. The animal enclosure of claim 1, wherein said first frame end and said second frame end have a flat base.

12. The animal enclosure of claim 11, wherein said first frame end and said second frame end are triangular in shape.

13. The animal enclosure of claim 1 further comprising a fastener carried on said shell adapted to attach vegetation to an exterior of said shell.

14. The animal enclosure of claim 1, wherein said shell is constructed of a mesh material.

15. The animal enclosure of claim 1 further comprising a securement member extending from one of said frame and said shell.

16. The animal enclosure of claim 1 further comprising a transport member attached to at least one of said frame and said shell.

17. The animal enclosure of claim 16, wherein said transport member includes a pair of eyes attached at either end of said shell and a shoulder strap having a first end attachable to one of said eyes and a second end attachable to a second of said eyes.

18. The animal enclosure of claim 1, wherein said first frame end and said second end are triangular shaped members and said biasing member is a coiled member having a triangular coil configuration, wherein said coiled member and said first frame end and said second frame end are constructed of plural wire segments connected to each other by couplers.

19. The animal enclosure of claim 18, wherein said couplers receive one end of one segment and one end of an adjacent segment on opposite sides thereof and are pivotable to allow collapsing of the frame.

20. The animal enclosure of claim 1 further comprising a liner located interiorally of said frame and attached to said shell.

21. An animal enclosure comprising:
a frame having a first frame end and a second frame end, and a coil spring member biasing said first frame end away
from said second frame end, said frame having a flat base;
a shell overlying said frame to define an enclosed space within said frame, said shell being open at each end, wherein said shell is constructed of fabric; and wherein said frame and said shell are movable between a collapsed condition and an open condition;
a liner located interiorly of said frame and attached to said shell to house said frame between said shell and said liner, wherein said liner is constructed of fabric.
